(19) United States
(12) Patent Application Publication
(10) Pub. No.: US 2020/0294481 A1
(43) Pub. Date: Sep. 17, 2020

(54) SOUND TRANSDUCER

(71) Applicant: Robert Bosch GmbH, Stuttgart (DE)

(72) Inventors: Andre Gerlach, Leonberg-Hoefingen (DE); Bernd Scheufele, Koengen (DE); Johannes Henneberg, Weil Im Schoenbuch (DE); Marko Liebler, Bretten (DE)

(21) Appl. No.: 16/645,245

(22) PCT Filed: Jul. 30, 2018
(86) PCT No.: PCT/EP2018/070547

§ 371 Date: Mar. 6, 2020

(30) Foreign Application Priority Data
Sep. 25, 2017 (DE) 102017216868.4

(51) Int. Cl. G10K 9/22; G01S 15/931; B60R 19/02; G10K 11/00; G10K 9/12

(52) U.S. Cl. CPC G10K 9/22; G01S 15/931; B60R 19/02; G01S 2015/938; G10K 11/002; G10K 9/12; G10K 11/004

(57) ABSTRACT

A sound transducer, in particular for an ultrasonic sensor, is described, which includes a housing, at least one decoupling element and a functional group. The functional group includes a diaphragm cup and at least one electroacoustic converter element. The diaphragm cup includes a vibratable diaphragm and a circumferential wall as well as at least one electroacoustic converter element, the converter element being configured to excite the diaphragm to vibrations and/or to convert vibrations of the diaphragm into electrical signals. The diaphragm cup and at least one part of the housing are made from a plastic material. The decoupling element is configured to vibration-mechanically decouple the diaphragm cup and/or the at least one part of the housing from outer surroundings of the sound transducer. The decoupling element is integrated into the diaphragm cup, in particular into the wall of the diaphragm cup, and/or the at least one part of the housing.

### FIELD OF THE INVENTION

The present invention relates to a sound transducer, which includes a diaphragm cup, a converter element, and a housing. The diaphragm cup includes a diaphragm and a wall. In addition, the sound transducer includes a decoupling element. The present invention further relates to a method for manufacturing the sound transducer.

### BACKGROUND INFORMATION

Ultrasonic sensors are used, among other things, in automotive and industrial applications to detect the surroundings. Objects in the surroundings may be detected in that an ultrasonic signal is transmitted by the ultrasonic sensor and the ultrasonic echo reflected by an object is received. The distance from the object may then be calculated from the propagation time between the transmission of the ultrasonic signal and the receipt of the ultrasonic echo as well as the known sonic velocity.

To ensure a vibration-mechanical decoupling between the ultrasonic sensor and its installation environment, decoupling elements are presently mounted between the ultrasonic sensor and the installation surroundings. The decoupling elements are made from flexible materials having a high material damping, for example silicone. The publication DE 10 2015 115 419 A1 may be mentioned as an example of this, in which a decoupling element in the form of a rubber ring is mounted on the diaphragm cup, and the diaphragm cup is thus centered in the installation position, on the one hand, and is vibration-mechanically decoupled from the outer casing part, on the other hand.

### SUMMARY OF THE INVENTION

On this basis, the object of the present invention is to develop a sound transducer having a simplified manufacturing method and a simplified structure.

To achieve the object, a sound transducer, in particular for an ultrasonic sensor, is described, which includes a housing, at least one decoupling element, and a functional group. The functional group includes a diaphragm cup and at least one electroacoustic converter element. The diaphragm cup includes a vibratable diaphragm and a circumferential wall and at least one electroacoustic converter element, the converter element being configured to excite the diaphragm to vibrations and/or to convert vibrations of the diaphragm into electrical signals. The diaphragm cup and at least one part of the housing are made from a plastic material. The decoupling element is configured to vibration-mechanically decouple the diaphragm cup and/or the at least one part of the housing from outer surroundings of the sound transducer. A material having good damping properties for this purpose is, for example, silicone. The outer surroundings of the sound transducer are, in particular, installation surroundings of the sound transducer. Ultrasonic sensors are usually installed in recesses at the bumper of vehicles.

According to the present invention, the at least one decoupling element is integrated into the diaphragm cup. In particular, the at least one decoupling element is integrated into the wall of the diaphragm cup. Alternatively or additionally, according to the present invention, the at least one decoupling element is integrated into the at least one part of the housing. Due to the integration of the coupling element and the resulting one-part configuration of the functional group and/or the at least one part of the housing together with the decoupling element, the structure of the sound transducer is significantly simplified, compared to conventionally manufactured sound transducers whose components are mounted individually. The sound transducer also achieves an additional robustness against environmental influences. In one embodiment of the present invention, the at least one part of the housing and the function group of the sound transducer may have a one-piece configuration or be configured as one component made from the plastic material. A thermoplastic or thermosetting material may be used for this purpose. In one embodiment of the present invention, the at least one part of the housing and the function group of the sound transducer may alternatively have a one-piece configuration or be configured as one component as a fiber-plastic composite component. Carbon, glass or aramid fiber-reinforced epoxy resins may be used as materials with very good suitability. Due to the one-piece configuration of the at least one part of the housing, the functional group of the sound transducer as well as the integrated decoupling element thus result in a sound transducer having a simple and particularly robust structure.

The at least one decoupling element may be situated between the outer surroundings of the sound transducer and the diaphragm cup and/or the at least one part of the housing. The outer surroundings of the sound transducer are, in particular, installation surroundings of the sound transducer. The wall of the diaphragm cup often directly abuts the installation surroundings of the sound transducer, whereby the decoupling element situated in the clearance may particularly effectively prevent the transfer of vibrations between the diaphragm cup and the installation surroundings. The at least one part of the housing is, in particular, the part of the housing which directly abuts the installation surroundings of the sound transducer. The decoupling element situated in the clearance may thus particularly effectively prevent the transfer of vibrations between the at least one part of the housing and the installation surroundings.

The decoupling element may have at least one recess. The plastic material from which the diaphragm cup and the at least one part of the housing are made fills this recess in such a way that the at least one decoupling element is connected to the diaphragm cup and/or the at least one part of the housing in a form-fitting manner and/or is fixedly bonded. The recess may be a hole recess of the decoupling element. The diaphragm cup and/or the at least one part of the housing include(s) a plastic pin in this case, which passes through the hole recess and thus protects the decoupling element connected in a form-fitting manner against radial displacement. In this embodiment, a fixedly bonded connection also occurs, so that the decoupling element is also unable to detach axially. This is a simple method for integrating the decoupling element into the diaphragm cup, in particular into the wall of the diaphragm cup and/or the at least one part of the housing. The form-fitting and fixedly bonded connection between the at least one decoupling element and the diaphragm cup and/or the at least one part of the housing may be provided with a non-detachable configuration. A more robust structure of the sound transducer thus results, compared, for example, to a conventional sound transducer, in which the decoupling element is detachably mounted onto the corresponding component. The recess of the decoupling element may also be an undercut of the decoupling element. This undercut is filled by the plastic material, so that the at least one decoupling element is connected to the diaphragm cup and/or the at least one part of the housing in a form-fitting manner. Due to the undercut, the form-fitting connection has a non-detachable configuration. In addition, a fixedly bonded connection may predominate.

The decoupling element may be at least partially embedded in the diaphragm cup and/or the at least one part of the housing in such a way that the at least one decoupling element is connected to the diaphragm cup and/or the at least one part of the housing in a form-fitting manner. For this purpose, the circumferential decoupling element has, for example, a subarea which has a greater wall thickness than the rest of the area of the decoupling element. The subarea having the thicker wall thickness is fully enclosed by the plastic material, so that a form-fitting connection to the diaphragm cup and/or the at least one part of the housing results.

The at least one decoupling element may adhere to the plastic material, in particular a thermosetting plastic, of the functional group of the sound transducer in such a way that the decoupling element is integrally connected to the at least one part of the housing and/or to the wall of the diaphragm cup. For example, an epoxy resin may be used as the plastic material. This fixedly bonded connection between the diaphragm cup and the decoupling element and/or the at least one part of the housing and the decoupling element may be implemented if the decoupling element is wetted by the plastic material during the manufacturing process. For this purpose, a thermosetting material may be used as the plastic material. Due to the adhesive properties of the material, a non-detachable, fixedly bonded connection occurs between the diaphragm cup and/or the housing and the at least one decoupling element. This fixedly bonded connection is comparable to an adhesive connection, however no adhesive being used but rather the adhesive material property of the base material being used for the connection. It should be noted that the adhesive properties of the material of the housing and/or the wall of the diaphragm cup are matched to the adhesive properties of the material of the decoupling element to achieve a permanent fixedly bonded connection.

Form-fitting variants of the integration of the decoupling element may also be combined with the fixedly bonded variants.

The manufacturing method according to the present invention permits the easy and economical manufacture of a sound transducer, for example for an ultrasonic sensor, based on at least one decoupling element integrated into the diaphragm cup. As a result, labor-intensive mounting steps for coupling the decoupling element to the diaphragm cup may be eliminated during manufacturing, which results in a simplified construction process. During the manufacturing process, the at least one decoupling element is initially introduced into a first cavity of a die of an injection-molding machine. The injection of a plastic material into the first cavity then takes place, the decoupling element at least partially abutting the plastic material. Alternatively or additionally, the decoupling element is at least partially filled by the injected plastic material. Alternatively or additionally, the decoupling element is further at least partially enclosed by the plastic material, so that it is at least partially embedded in the plastic material after the curing of the plastic material. A diaphragm cup according to the description herein results, including a wall, a vibratable diaphragm and a decoupling element. The at least one decoupling element is integrated into the diaphragm cup, in particular into the wall of the diaphragm cup. Alternatively, the plastic material is not injected but rather may be cast into a casting mold.

The functional group of the sound transducer and the housing may be manufactured in one work step as a one-part overall component. The structure of the sound transducer is further simplified and made more robust thereby. In one method step, at least one electroacoustic converter element may furthermore be introduced into a second cavity of the die of the injection molding machine. In a subsequent method step, the plastic material is injected into the second cavity, so that at least one converter element is at least partially enclosed by the plastic material, and the converter element is integrated into the vibratable diaphragm. This results in a closed, one-piece component having an increased robustness against environmental influences, such as the penetration of moisture or contaminants.

### BRIEF DESCRIPTION OF THE DRAWINGS

FIG. 1 schematically shows a sound transducer according to a first specific embodiment of the present invention, including a plug housing.

FIG. 2 schematically shows a sound transducer according to a second specific embodiment of the present invention, including a plug housing.

FIG. 3 schematically shows a sound transducer according to a third specific embodiment of the present invention.

FIG. 4 schematically shows a sound transducer according to a fourth specific embodiment of the present invention.

FIG. 5 schematically shows a sound transducer according to a fifth specific embodiment of the present invention.

FIG. 6 schematically shows a sound transducer according to a sixth specific embodiment of the present invention.

FIG. 7 schematically shows a flowchart of a possible configuration of a method according to the present invention for manufacturing a sound transducer.

### DETAILED DESCRIPTION

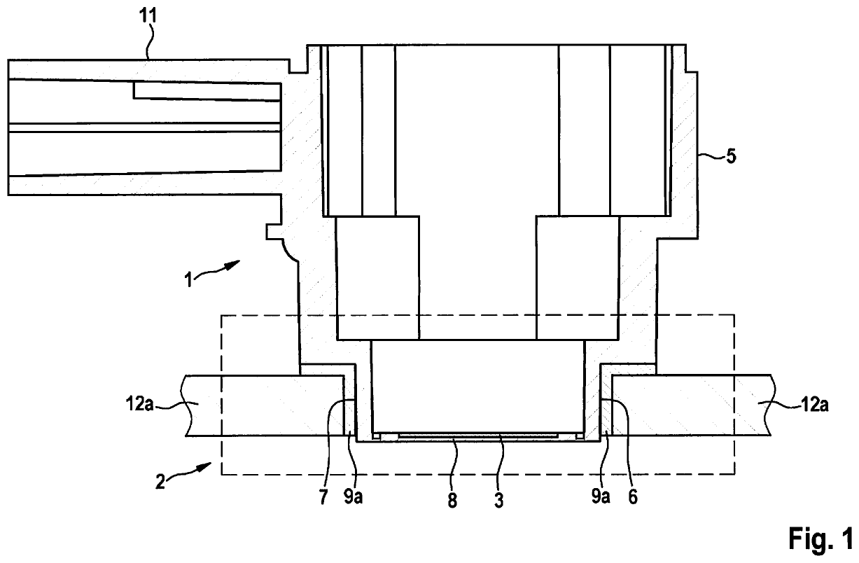

FIG. 1 schematically shows a sectional view of a sound transducer 1 according to a first embodiment of the present invention. The sound transducer includes a housing 5 having a plug housing 11. The sound transducer includes a functional group 2, which is configured as a single part with the housing. The functional group includes a diaphragm cup 6, which has a vibratable diaphragm 8 and a circumferential wall 7. Diaphragm 8 may have, for example, a circular or elliptical shape. The diaphragm has subareas of a reduced thickness or a reduced wall thickness. The vibration behavior and the resonance frequency of sound transducer 1 are determined by the geometric shape of these areas. Diaphragm cup 6 is provided with a one-part configuration in this example. Circumferential wall 7 furthermore transitions directly into housing 5, plug housing 11 also having a one-part configuration with housing 5. Sound transducer 1 also includes a converter element 3, which in this example is integrated into diaphragm 8. In this specific embodiment, decoupling element 9a is fixedly bonded to wall 7 of diaphragm cup 6 and is thus integrated into the wall of diaphragm cup 6. In this example, decoupling element 9a adheres to the outside of wall 7.

Sound transducer 1 in this first specific embodiment is installed in a component 12a. Component 12a may represent, for example, a bumper of a vehicle. Decoupling element 9a makes it possible to prevent vibrations from being transferred from diaphragm cup 6 to the component and vice versa.

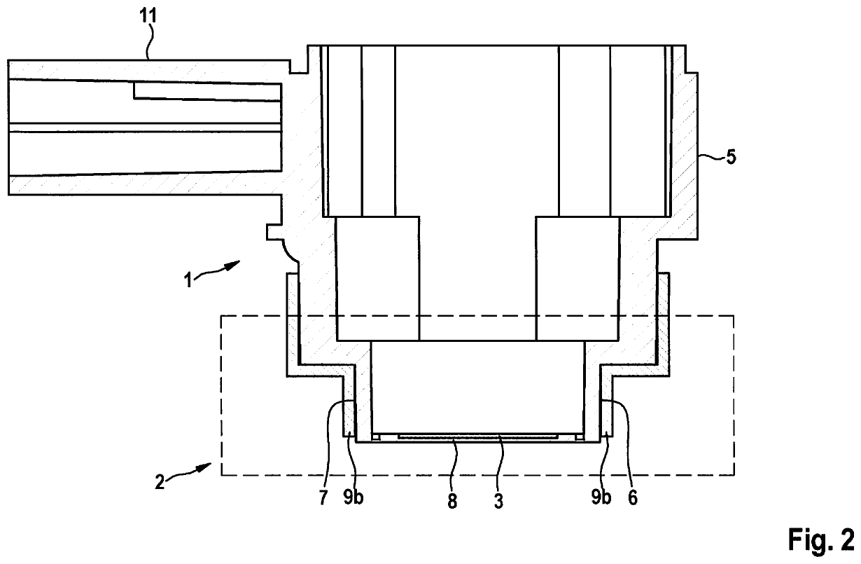

In contrast to FIG. 1, FIG. 2 shows a decoupling element 9b, which is integrated in a fixedly bonded manner into wall 7 of diaphragm cup 6 as well as into a part of housing 5. Decoupling element 9b makes it possible to prevent vibrations from being transferred from diaphragm cup 6 or from the part of housing 5 to the outer surroundings of the sound transducer and vice versa.

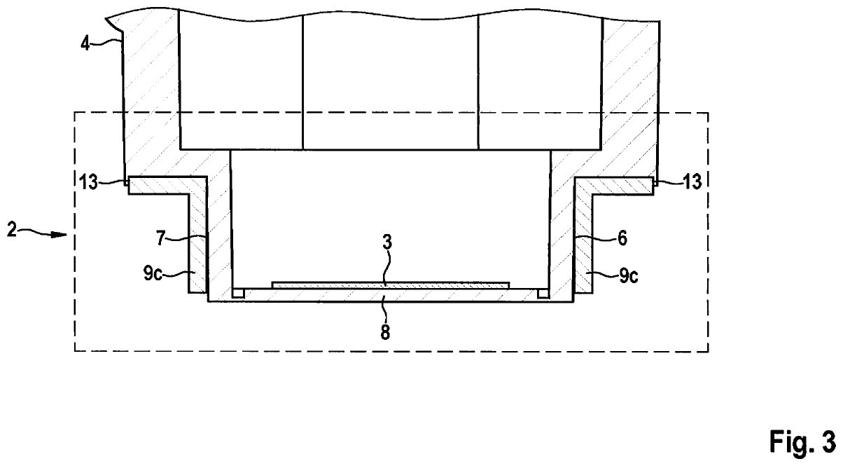

In contrast to FIG. 1, FIG. 3 shows a configuration, in which decoupling element 9c is embedded into diaphragm cup 6 on one side. The decoupling element thus abuts circumferential edge 13 and is better protected against slipping caused by introduced shearing forces.

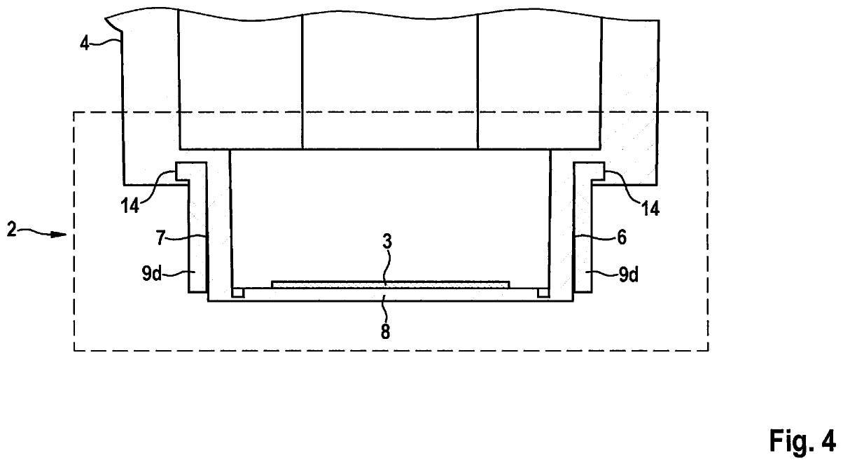

FIG. 4 shows a fourth specific embodiment of the sound transducer according to the present invention. Decoupling element 9d is at least partially embedded in diaphragm cup 6 in such a way that the at least one decoupling element 9d is connected to diaphragm cup 6 in a form-fitting manner. Circumferential decoupling element 9d has a subarea 14, which has a thicker wall thickness than the remaining area of the decoupling element. This subarea 14 is completely enclosed by the plastic material, so that the decoupling element is connected to the diaphragm cup and/or the at least one part of the housing in a form-fitting manner.

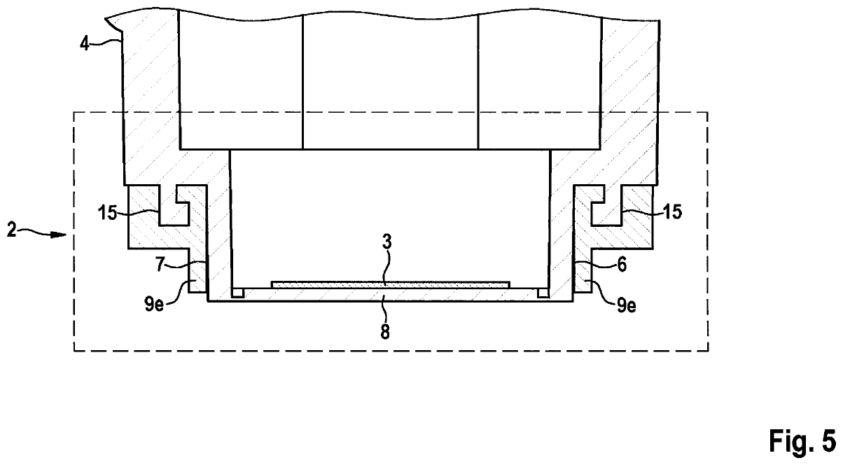

FIG. 5 shows a fifth specific embodiment of the sound transducer according to the present invention. Circumferential decoupling element 9e has a recess 15 in the form of an undercut. The plastic material of diaphragm cup 6 fills this undercut in such a way that decoupling element 9e is connected to diaphragm cup 6 in a form-fitting manner.

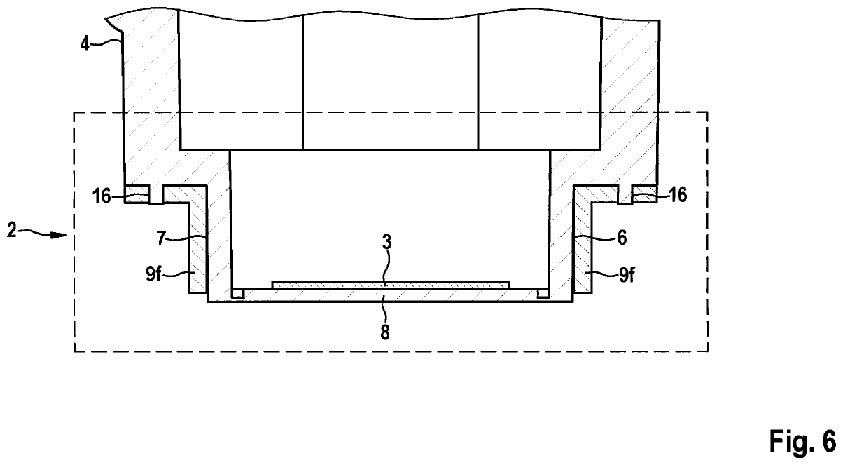

FIG. 6 shows a sixth specific embodiment of the sound transducer according to the present invention, decoupling element 9f having a recess 16 in the form of a hole recess. This recess 16 is filled by the plastic material of diaphragm cup 6 in such a way that decoupling element 9f is connected to diaphragm cup 6 in a form-fitting manner.

In the fourth, fifth and sixth specific embodiments, it would also be conceivable if the decoupling element were additionally connected in a fixedly bonded manner to the diaphragm cup, in particular to the wall of the diaphragm cup. A combination of the different form-fitting connections would also be conceivable.

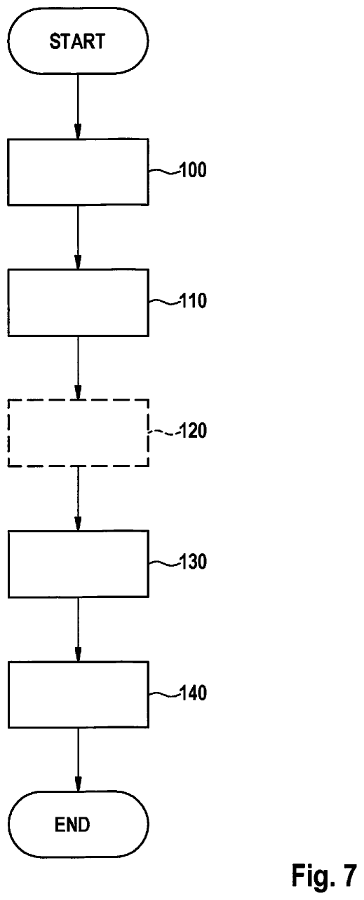

FIG. 7 illustrates the sequence of a manufacturing method according to the present invention for a sound transducer according to the present invention.

In step 100, a plastic processing die including a first cavity is provided, whose shape is adapted to the desired shape of the sound transducer.

In step 110, at least one decoupling element is introduced into the first cavity.

In step 130, a plastic material, for example an epoxy resin, is injected into the first cavity, whereby a diaphragm cup is formed, which includes a wall, a vibratable diaphragm and a decoupling element. The at least one decoupling element is integrated into the diaphragm cup, in particular into the wall of the diaphragm cup. For the purpose of integration, the decoupling element at least partially abuts the plastic material and/or is at least partially filled by the plastic material and/or is at least partially enclosed by the plastic material. If the first cavity is provided with a corresponding configuration, the housing may also be formed in one component in addition to the diaphragm cup including the wall, the vibratable diaphragm and the at least one decoupling element.

In step 140, the component is removed, if necessary after a solidification period.

In an optional method step 120, which follows method step 110, at least one electroacoustic converter element is introduced into a second cavity of the die of the injection molding machine. During the subsequent injection of the plastic material, the at least one converter element is at least partially enclosed by the plastic material and integrated into the vibratable diaphragm.

1-12. (canceled)

13. A sound transducer, comprising:
a housing; and
at least one decoupling element, and a functional group, the functional group including a diaphragm cup and at least one electroacoustic converter element;
wherein the diaphragm cup includes a vibratable diaphragm and a wall,
wherein the at least one converter element is configured to excite the diaphragm to vibrations and/or to convert the vibrations of the diaphragm into electrical signals,
wherein at least the diaphragm cup and at least one part of the housing is made from a plastic material,
wherein the at least one decoupling element is configured to vibration-mechanically decouple the diaphragm cup and/or the at least one part of the housing from outer surroundings of the sound transducer, in particular installation surroundings of the sound transducer, and
wherein the at least one decoupling element is integrated into the diaphragm cup, in particular into the wall of the diaphragm cup and/or the at least one part of the housing.

14. The sound transducer of claim 13, wherein the at least one decoupling element is situated between the outer surroundings of the sound transducer, in particular the installation surroundings of the sound transducer and the diaphragm cup and/or the at least one part of the housing.

15. The sound transducer of claim 13, wherein the decoupling element has at least one recess, the plastic material filling the recess so that the at least one decoupling element is connected to the diaphragm cup and/or the at least one part of the housing in a form-fitting or fixedly bonded manner.

16. The sound transducer of claim 15, wherein the at least one recess represents an undercut.

17. The sound transducer of claim 15, wherein the at least one recess represents a hole recess.

18. The sound transducer of claim 13, wherein the decoupling element is at least partially embedded in the diaphragm cup and/or the at least one part of the housing so that the at least one decoupling element is connected to the diaphragm cup and/or the at least one part of the housing in a form-fitting manner.

19. The sound transducer of claim 13, wherein the functional group of the sound transducer and the at least one part of the housing are formed as a single piece from the plastic material or as a fiber-plastic composite component.

20. The sound transducer of claim 19, wherein the at least one decoupling element adheres to the plastic material, in particular a thermosetting plastic, of the functional group of the sound transducer so that the decoupling element is fixedly bonded to the at least one part of the housing and/or to the wall of the diaphragm cup.

21. A method for manufacturing a sound transducer, the method comprising:
introducing at least one decoupling element into a first cavity of a die of an injection molding machine; and
injecting a plastic material into the first cavity, the decoupling element at least partially abutting the plastic material, and/or being filled by the plastic material, and/or being enclosed by the plastic material;
wherein a diaphragm cup, which includes a wall, a vibratable diaphragm and a decoupling element is formed, and wherein the at least one decoupling element is integrated into the diaphragm cup, in particular into the wall of the diaphragm cup, and
wherein the sound transducer includes:
a housing; and
the at least one decoupling element, and a functional group, the functional group including a diaphragm cup and at least one electroacoustic converter element;
wherein the diaphragm cup includes a vibratable diaphragm and a wall,
wherein the at least one converter element is configured to excite the diaphragm to vibrations and/or to convert the vibrations of the diaphragm into electrical signals,
wherein at least the diaphragm cup and at least one part of the housing is made from a plastic material,
wherein the at least one decoupling element is configured to vibration-mechanically decouple the diaphragm cup and/or the at least one part of the housing from outer surroundings of the sound transducer, in particular installation surroundings of the sound transducer, and
wherein the at least one decoupling element is integrated into the diaphragm cup, in particular into the wall of the diaphragm cup and/or the at least one part of the housing.

22. The method of claim 21, wherein the first cavity of the die of the injection molding machine is configured so that the diaphragm cup forms a single part with a housing of the sound transducer during the injection of the plastic material into the first cavity, the at least one decoupling element being integrated into the diaphragm cup, in particular into the wall of the diaphragm cup, and/or into the at least one part of the housing.

23. The method of claim 21, further comprising:
introducing at least one electroacoustic converter element into a second cavity of the die of the injection molding machine; and
injecting the plastic material into the second cavity, wherein the at least one converter element is at least partially enclosed by the plastic material, and wherein the converter element is integrated into the vibratable diaphragm.

24. An ultrasonic sensor, comprising:
a sound transducer, including:
a housing; and
at least one decoupling element, and a functional group, the functional group including a diaphragm cup and at least one electroacoustic converter element;
wherein the diaphragm cup includes a vibratable diaphragm and a wall,
wherein the at least one converter element is configured to excite the diaphragm to vibrations and/or to convert the vibrations of the diaphragm into electrical signals,
wherein at least the diaphragm cup and at least one part of the housing is made from a plastic material,
wherein the at least one decoupling element is configured to vibration-mechanically decouple the diaphragm cup and/or the at least one part of the housing from outer surroundings of the sound transducer, in particular installation surroundings of the sound transducer, and
wherein the at least one decoupling element is integrated into the diaphragm cup, in particular into the wall of the diaphragm cup and/or the at least one part of the housing.
